(19) United States
(12) Patent Application Publication
(10) Pub. No.: US 2003/0002497 A1
(43) Pub. Date: Jan. 2, 2003

(54) Method and apparatus to reduce packet traffic across an I/O bus

(76) Inventor: Anil Vasudevan, Portland, OR (US)

Correspondence Address: ANTONELLI TERRY STOUT AND KRAUS, SUITE 1800, 1300 NORTH SEVENTEENTH STREET, ARLINGTON, VA, 22209

(21) Appl. No.: 09/893,888

(22) Filed: Jun. 29, 2001

(51) Int. Cl. H04L 12/66

(52) U.S. Cl. 370/389; 370/352

(57) ABSTRACT

A method and apparatus are provided for transferring data packets between a server and a client. This may involve receiving a data packet from a stack in the server, sending an acknowledgment packet to the stack and transmitting the data packet across an I/O bus in the server. The acknowledgment packet may be sent to the stack without sending the acknowledgment packet across the I/O bus.

### FIELD

The present invention is directed to a computer network. More particularly, the present invention is directed to a method and apparatus for reducing packet TCP/IP traffic across an I/O bus.

### BACKGROUND

Congestion control in modern networks is increasingly becoming an important issue. The explosive growth of Internet applications such as the World Wide Web (www) has pushed current technology to its limit, and it is clear that faster transport and improved congestion control mechanisms are required. As a result, many equipment vendors and service providers are turning to advanced networking technology to provide adequate solutions to the complex quality of service (QoS) management issues involved . Examples include asynchronous transfer mode (ATM) networks and emerging Internet Protocol (IP) network services. Nevertheless, there is still the need to support a host of existing legacy IP protocols within these newer paradigms. In particular, the ubiquitous Transmission Control Protocol (TCP) transport-layer protocol has long been the workhorse transport protocol in IP networks, widely used by web-browsers, file/email transfer services, etc.

Transmission Control Protocol is part of the TCP/IP protocol family that has gained the position as one of the world's most important data communication protocols with the success of the Internet TCP provides a reliable data connection between devices using TCP/IP protocols. TCP/IP networks are nowadays probably the most important of all networks, and operate on top of several physical networks, such as ATM networks. TCP operates on top of IP that is used for packing the data to data packets, called datagrams, and for transmitting across the networks.

The Internet Protocol is a network layer protocol that routes data across the Internet. The Internet Protocol was designed to accommodate the use of host and routers built by different vendors, encompass a growing variety of growing network types, enable the network to grow without interrupting servers, and support a higher layer of session and message-oriented services. The IP network layer allows integration of Local Area Network (LAN) islands. However, IP doesn't contain any flow control or retransmission mechanisms. As such, TCP is typically used on top of IP. TCP also uses acknowledgment packets for detecting lost data packets. Each of these acknowledgment packets needs to be processed which slows down the processing unit and I/O bus of the host server.

### BRIEF DESCRIPTION OF THE DRAWINGS

The foregoing and a better understanding of the present invention will become apparent from the following detailed description of example embodiments and the claims when read in connection with the accompanying drawings, all forming a part of the disclosure of this invention. While the foregoing and following written and illustrated disclosure focuses on disclosing example embodiments of the invention, it should be clearly understood that the same is by way of illustration and example only and that the invention is not limited thereto.

The following represents brief descriptions of the drawings in which like reference numerals represent like elements and wherein:

FIG. 1 illustrates a computer system platform;

FIG. 2 illustrates a network system wherein a receiver provides acknowledgment packets to a source as well as receives data from the source;

FIG. 3 illustrates an arrangement for sending data and receiving acknowledgment packets;

FIG. 4 illustrates an arrangement for sending data and receiving acknowledgment packets according to an example embodiment of the present invention; and

FIG. 5 illustrates a method according to an example embodiment of the present invention.

### DETAILED DESCRIPTION

In the following detailed description, like reference numerals and characters may be used to designate identical, corresponding or similar components in differing figure drawings. Embodiments and arrangements may be shown in block diagram form in order to avoid obscuring the invention and also in view of the fact that specifics with respect to implementation of such block diagram arrangements may be highly dependent upon the platform within which the present invention is to be implemented. That is, such specifics should be well within the knowledge of one skilled in the art. Where specific details (e.g., circuits, flowcharts) are set forth in order to describe example embodiments of the invention, it should be apparent to one skilled in the art that the invention can be practiced without, or with variation of, these specific details. Finally, it should be apparent that differing combinations of hard-wired circuitry and software instructions may be used to implement embodiments of the present invention. That is, the present invention is not limited to any specific combination of hardware and software.

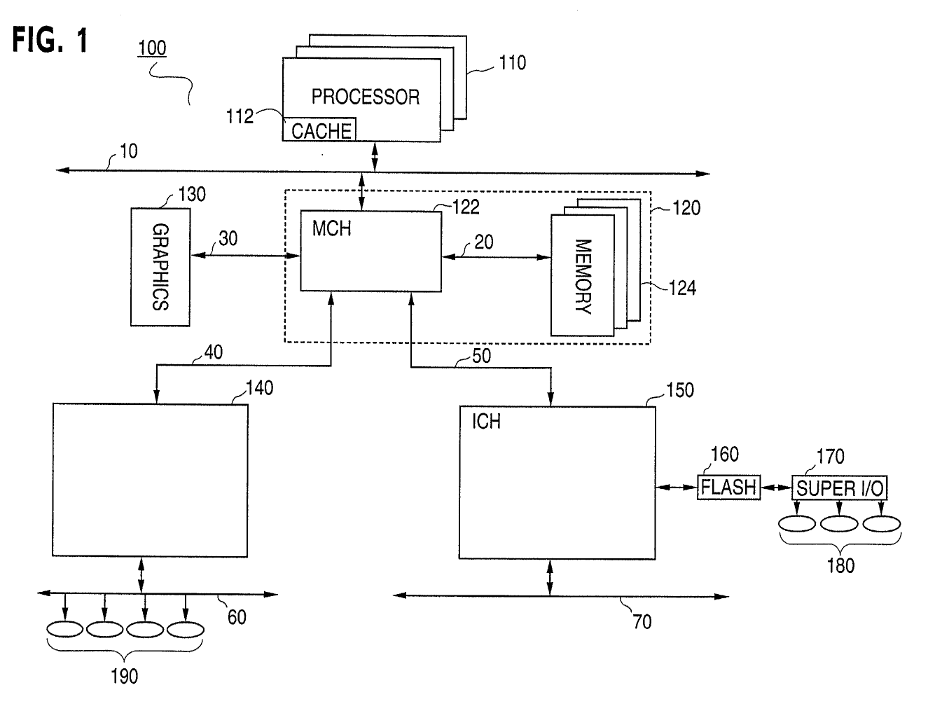

FIG. 1 illustrates a computer system platform according to an example embodiment of the present invention. Other embodiments, mechanisms and platforms are also within the scope of the present invention. As shown in FIG. 1, the computer system 100 may include a processor subsystem 110, a memory subsystem 120 coupled to the processor subsystem 110 by a front side bus 10, graphics 130 coupled to the memory subsystem 120 by a graphics bus 30, one or more host chipsets 140, 150 coupled to the memory subsystem 120 by hub links 40 and 50 for providing an interface with peripheral buses such as Peripheral Component Interconnect (PCI or PCI-X) buses 60 and 70 of different bandwidth and operating speeds, a flash memory 160, and a super 110 170 coupled to the chipset 150 by a low pin count (LPC) bus for providing and interfacing with a plurality of I/O devices 180 including, for example, a keyboard controller for controlling operations of an alphanumeric keyboard, a cursor control device such as a mouse, track ball, touch pad, joystck, etc., a mass storage device such as magnetic tapes, hard drives (HDD), and floppy disk drives (FDD), and serial and parallel ports to printers, scanners, and display devices. A plurality of I/O devices 190 may be coupled to the system by the PCI or PCI-X bus 60. The computer system 100 may be configured differently or employ different components than those shown in FIG. 1.

The processor subsystem 110 may include a plurality of host processors and a cache subsystem 112. The memory subsystem 120 may include a memory controller hub (MCH) 122 coupled to the host processors by the front side bus 10 (i.e., host or processor bus) and at least one memory element 124 coupled to the MCH 122 by a memory bus 20. The memory element 124 may be a dynamic random-access-memory (DRAM), or may be a read-only-memory (ROM), a video random-access-memory (VRAM) and the like. The memory element 124 may store informaton and instructions for use by the host processors. The graphics 130 may be coupled to the main controller hub 122 of the memory subsystem 120 by the graphic bus 30, and may include, for example, a graphics controller, a local memory and a display device (e.g., cathode ray tube, liquid crystal display, flat panel display, etc.).

The host chipsets 140 and 150 may be Peripheral Component Interconnect (PCI or PCI-X) bridges (e.g., host, PCI-PCI, or standard expansion bridges) in the form of PCI chips such as, for example, the PIIX4 chip and PIIX6 chip manufactured by Intel Corporation. In particular, the chipsets 140 and 150 may correspond to a Peripheral Component Interconnect (PCI or PCI-X) 64-bit hub (P64H or P64H2 bridge) and an inpuVoutput controller hub (ICH). Arrangements are also applicable to a P64H2 bridge (or hub) although the following arrangements may be described with respect to the P64H bridge (or hub). Further, although not shown, the chipset 140 may be coupled to more than one bus 60.

The P64H bridge (chipset 140) and the ICH (chipset 150) may be coupled to the MCH 122 of the memory subsystem 120, respectively, by 16 bit and 8 bit hub links 40 and 50, for example, and may operate as an interface between the front side bus 10 and the peripheral buses 60 and 70 such as PCI buses of different bandwidths and operating speeds. The PCI buses may be high performance 32 or 64 bit synchronous buses with automatic configurability and multiplexed address, control and data lines as described in the latest version of “PCI Local Bus Specification, Revision 2.2” set forth by the PCI Special Interest Group (SIG) on Dec. 18, 1998 for add-on arrangements (e.g., expansion cards) with new video, networking, or disk capabilities or as described with respect to the latest version of “PCI-X Addendum to the PCI Local Bus Specification, revision 1.0a” set forth by the PCI Special Interest Group on Jul. 24, 2000. A PCI bus of 64-bits and 66 MHz may connect to the P64H bridge (chipset 140) or a PCI bus of 32-bits and 33 MHz may connect to the ICH (chipset 150). Other types of bus architectures such as Industry Standard Architecture (ISA), Expanded Industry Standard Architecture (EISA) and PCI-X buses may also be utilized. These buses may operate at different frequencies such as 33 MHz, 66 MHz, 100 MHz and 133 MHz, for example. Other frequencies are also within the scope of the present invention.

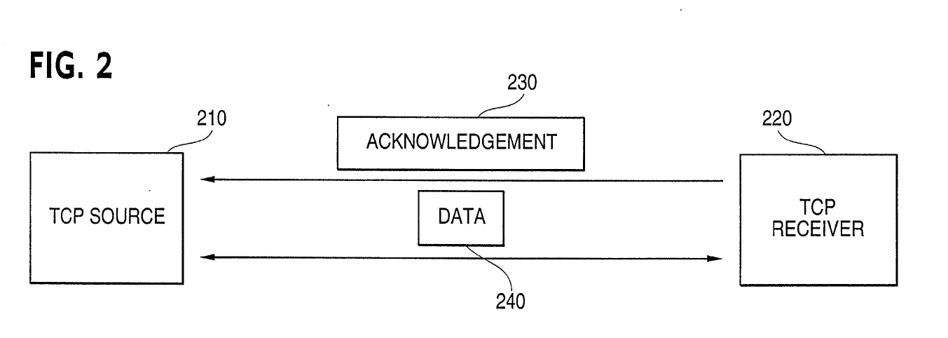

FIG. 2 illustrates a TCP network system and how data may be exchanged. More specifically, FIG. 2 shows a TCP source 210 (such as the computer system platform shown in FIG. 1) that transmits data 240 to a TCP receiver 220 across a network. The TCP receiver 220 may provide an acknowledgment packet 230 to the TCP source 210 after receiving the data 240. Although not shown, the TCP source 210 may also be exchanging data (and acknowledgment packets) with other TCP receivers (not shown).

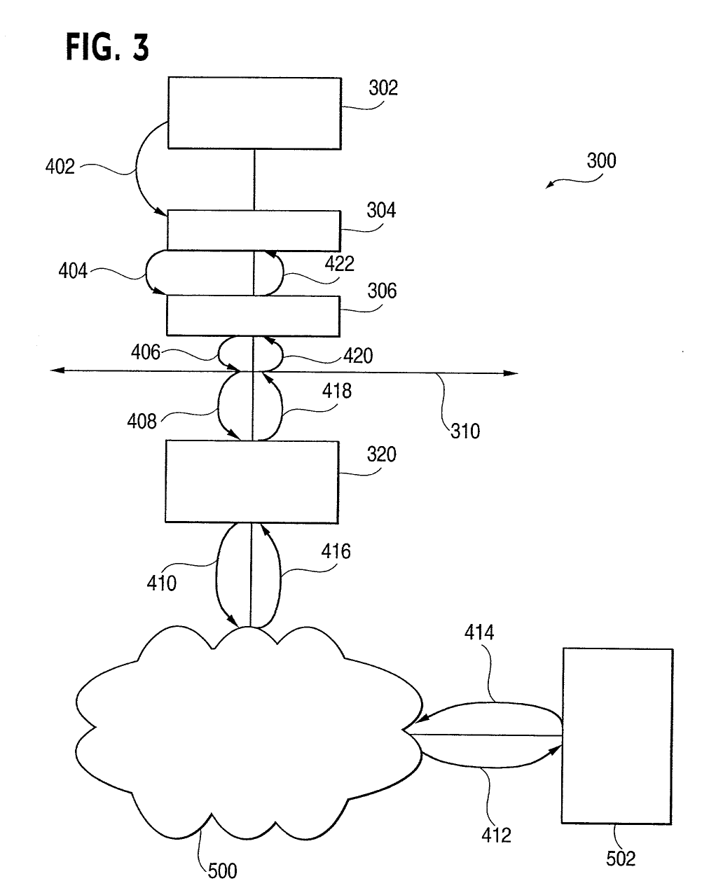

FIG. 3 illustrates how the TCP source (such as the TCP source 210) may handle the respective data and acknowledgment packets according to an example arrangement. Other arrangements are also possible. More specifically, FIG. 3 shows a computer system 300 (similar to the computer architecture shown in FIG. 1) that includes an operating system having a network application mechanism 302 and a TCP/IP stack mechanism 304. A network driver mechanism 306 may also be provided to communicate with an I/O bus 310 such as a PCI bus or a PCI-X bus. The TCP source may also include a network hardware apparatus such as a network interface card (NIC) 320. The network driver mechanism 306 and the NIC 320 may be separately coupled to the I/O bus 310 and the NIC 320 so as to communicate data. The NIC 320 may be further coupled to a network 500 so as to provide an interface between the computer system 300 and the network 500. For illustration purposes, FIG. 3 shows a remote computer system 502 (similar to the TCP receiver 220 in FIG. 2) coupled to the network 500. The remote computer system 502 may include architecture similar to the computer platform shown in FIG. 1. Other computer systems may be similarly coupled to the network 500.

The FIG. 3 arrangement will now be described by showing operations labeled by arrows 402-422. The network application mechanism 302 may send data using network programming application programming interface (APIs). The application data may be sent from the network application mechanism 302 to the TCP/IP stack mechanism 304 (arrow 402). The TCP/IP stack mechanism 304 may segment the data into smaller packets and pass the smaller packets to the network driver mechanism 306 (arrow 404). Once the TCP/IP stack mechanism 306 has sent data (up to a particular window size), then it may wait for an acknowledgment packet (such as the acknowledgment packet 230 shown in FIG. 2) regarding that specific data before sending a next batch of data packets to the same remote system (i.e., on a particular connection). The data may be transmitted across the I/O bus 310 (arrow 406 and 408), and through the NIC 320 to the network 500 (arrow 410). In this example, the network 500 may appropriately route the data to the remote computer system 502 (arrow 412).

Upon receiving the data, the remote computer system 502 may thereafter generate an acknowledgment packet (such as the TCP acknowledgment packet 230 in FIG. 2) and transmit that packet back though the network 500 (arrow 414) to the NIC 320 (arrow 416). In this arrangement, the NIC 320 may thereafter generate an interrupt to the processing unit. The interrupt may cause the processing unit to transfer control to the network driver mechanism 306, which in turn, may read data from the NIC 320 (arrow 418 and 420) and pass it to the TCP/IP stack mechanism 304 (arrow 422). The acknowledgment packets may not be forwarded to the network application mechanism 302; rather, the network application mechanism 302 may only send and receive application specific data. Once the TCP/IP stack mechanism 304 receives the acknowledgment packets, the TCP/IP stack mechanism 304 may continue to send additional application data on that connection to the remote computer system 502.

It is desirable to reduce the I/O bus overhead for transmission of data packets up to, or even more than, the window size permitted by TCP/IP. That is, with the increasing speed of networking devices, the required processing unit bandwidth to handle the traffic at these speeds is scarce. For example, sustaining a near gigabyte throughput on a server may put the fastest processing unit to a near maximum utilization in addition to consuming a significant portion of the I/O bandwidth that is shared with other I/O devices. It may therefore be desirable to improve upon the overall system performance by reducing the number of interrupts and placing some of the burden of receiving the TCP acknowledgment packets on a network interface card with additional functionality. That is, for a heavily loaded host server, the number of TCP acknowledgment packets received by the host sever (such as the computer system 300) may be considerable. The host server may have to wait and process TCP acknowledgment packets from different clients (i.e., different remote computer systems) that the host server is servicing. These acknowledgment packets may be small packets that need to be processed by the host server.

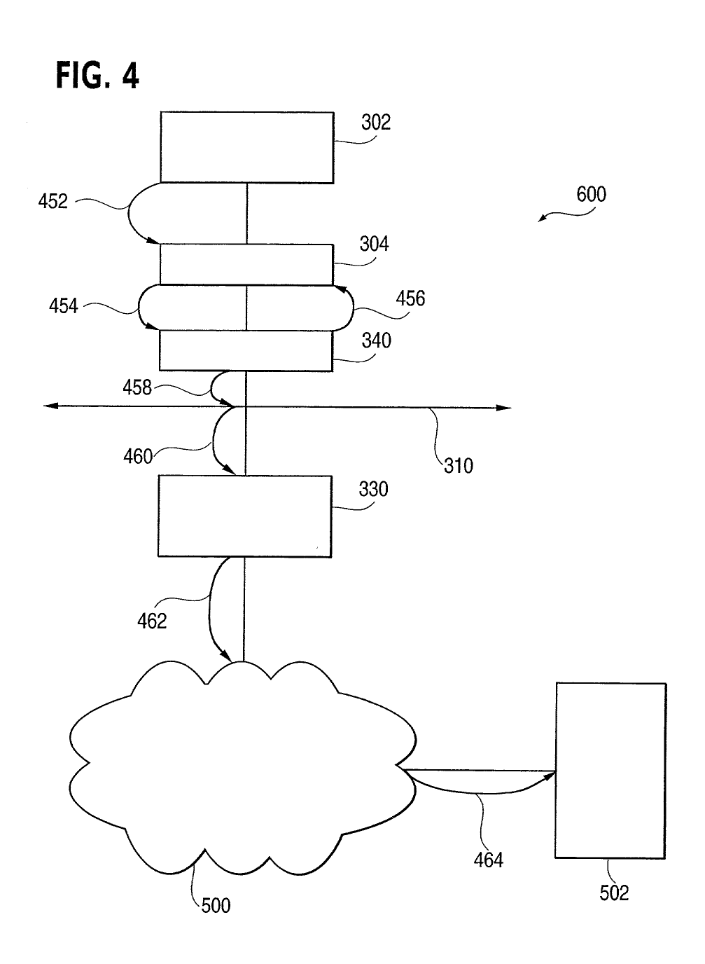

Accordingly, embodiments of the present invention may reduce the I/O bus overhead for transmission of data packets and acknowledgment packets between a server (i.e., a local computer system) and a client (i.e., a remote computer system). FIG. 4 illustrates how the TCP source (such as the TCP source 210) may handle the respective data and acknowledgment packets according to an example embodiment of the present invention. Other embodiments and configurations are also within the scope of the present invention. More specifically, FIG. 4 shows a computer system 600 that includes an operating system having the network application mechanism 302 and the TCP/IP stack mechanism 304. The FIG. 4 embodiment also includes a NIC 330 that includes additional functionality (than the NIC 320) to perform embodiments of the present invention. These additional functions may include storing data, monitoring real acknowledgment packets, generating error indications and negotiating with the network driver mechanism. The NIC 330 may therefore include additional logic circuits (e.g. a processor or logic gates) to perform these functions in addition to memory. The FIG. 4 embodiment further includes a network driver mechanism 340 with additional functionality such as generating fake acknowledgment packets and negotiating with the NIC 330 as will be described below.

The FIG. 4 embodiment will now be described by showing operations labeled by arrows 452-464. The order of operations and the numbering of the arrows is merely exemplary of this example as other orders and/or operations are also within the scope of the present invention. Application data may be sent from network application mechanism 302 to the TCP/IP stack mechanism 304 (arrow 452). The TCP/IP stack mechanism 304 may segment the data into smaller packets and pass the smaller packets to the network driver mechanism 340 (arrow 454). The network driver mechanism 340 may then send an acknowledgment packet (hereafter called a fake acknowledgment packet) back to the TCP/IP stack mechanism 304 (arrow 456). The data packet may be transmitted across the I/O bus 310 (arrows 458 and 460), and through the NIC 330 to the network 500 (arrow 462). In this example, the network 500 may appropriately route the data to the remote computer system 502 (arrow 464).

The acknowledgment packet (i.e., the fake acknowledgment packet) may be sent from the network driver mechanism 340 to the TCP/IP stack mechanism 304 (arrow 456) without sending the acknowledgment packet across the I/O bus 310. This may reduce the overhead of the I/O bus 310 and may therefore help speed up other operations. Information regarding the transmitted data packets may be stored in the NIC 330. The NIC 330 may monitor acknowledgment packets regarding the data packets from the remote computer system 502 so as to confirm that the remote computer system 502 received the data packets. If an acknowledgment packet regarding a data packet sent to the remote computer system 502 is not received at the NIC 330 within a predetermined amount of time, then the NIC 330 may determine that a error has occurred and may transmit an indication of this condition across the I/O bus 310.

Stated differently, when the network driver mechanism 340 receives a data packet from the TCP/IP stack mechanism 304 (arrow 454), the network driver mechanism 340 may generate a TCP acknowledgment packet and communicate that acknowledgment packet to the TCP/IP stack mechanism 304 (arrow 456). The acknowledgment packet does not cross the I/O bus 310 but rather is generated by the network driver mechanism 340. The network driver mechanism 340 may pass the data packet to the network hardware such as the NIC 330 (arrows 458 and 460). The network driver mechanism 340 may pass a data structure that contains connection information with the number of acknowledgment packets that is generated (i.e., the current state of the window size that the TCP stack mechanism 304 believes to be true). The NIC 330 may store this information and once an acknowledgment packet is received from the client (such as from the remote computer system 502), the NIC 330 may mark it is as received and continue processing the next batch of packets. If the NIC 330 does not receive an acknowledgment packet from the remote computer system 502 within the predetermined amount of time, then the NIC 330 may generate an error condition. For the sake of illustration, this may be called a negative acknowledgment packet and may be transmitted back across the I/O bus 310 to the network driver mechanism 340. Once the network driver mechanism 340 receives a negative acknowledgment packet, the network driver mechanism 340 may (depending on the severity): (a) stop sending acknowledgment packets to the TCP/IP stack mechanism 304 thereby putting the TCP/IP stack mechanism 304 in a block state; or (b) reset the connection with the remote computer system 502.

By utilizing embodiments of the present invention, the acknowledgment packets in the network driver mechanism 340 may not be transferred across the I/O bus 310 which thereby reduces the number of interrupts to the processing unit.

Accordingly, embodiments of the present invention improve the system performance and throughput by reducing the number of interrupts that are generated and reduce the data packet transfers across the I/O bus 310. This may lead to less utilization of the processing unit and efficient use of the I/O bus 310.

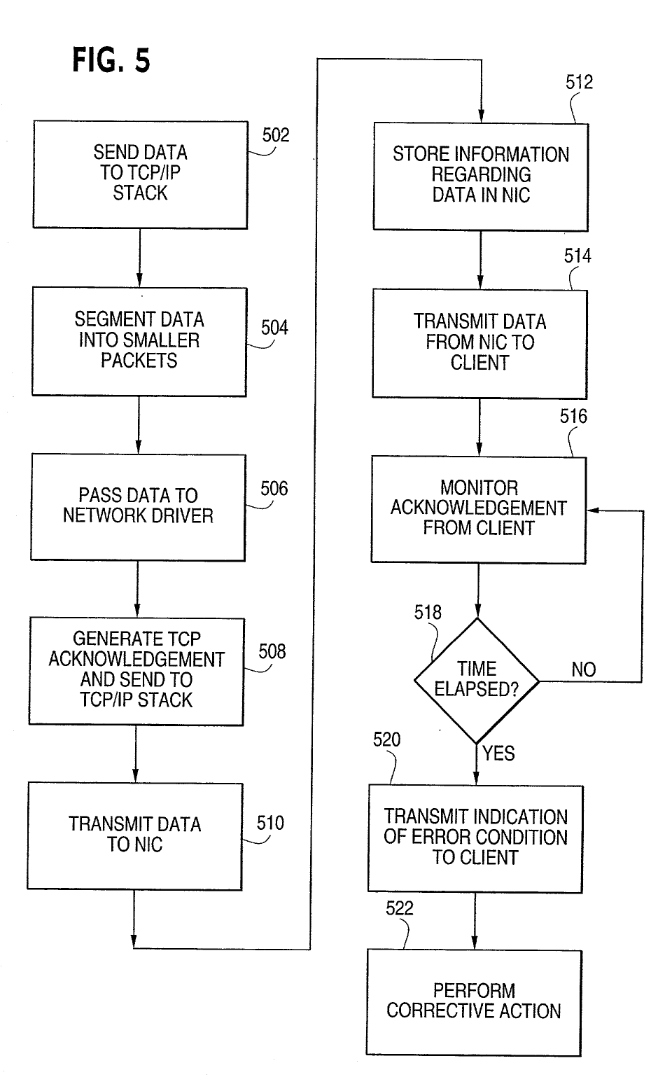

FIG. 5 is a flowchart of a method according to an example embodiment of the present invention. Other embodiments, orders of operation and different types of operations are also within the scope of the present invention. That is, FIG. 5 merely represents one example method.

As shown in FIG. 5, in block 502, data may be sent to the TCP/IP stack. This data may be segmented into smaller packets in block 504. The data may then passed to a network driver mechanism in block 506. In accordance with embodiments of the present invention, the network driver mechanism may generate a TCP acknowledgment packet (i.e., a fake acknowledgment packet) and send it to the TCP/IP stack in block 508. Data may be transmitted to a network interface card in block 510 which thereby stores information regarding the data in block 512. The data may be transmitted across the network from the network interface card to a client in block 504. In accordance with embodiments of the present invention, the network interface card may monitor return acknowledgment packets from the client in block 506. This may involve waiting a predetermined amount of time (block 518). During this time, the network interface card may store the packet that was unacknowledged in addition to any that were passed down to it from the network driver, i.e., packets that are queued. At such times, the network driver may stop sending acknowledgment packets to the TCP/IP stack, in order to impose flow control. The network interface card may continue to retransmit these packets in conformance with TCP/IP retransmission rules until such time it deems the connection broken. Storage of packets is partitioned between the network driver and the network interface card such that when the network interface card's internal buffers are full, the network driver performs the storage function. If a predetermined amount of time has elapsed, then an indication of an error condition may be transmitted from the network interface card to the driver mechanism in block 520. Corrective action may thereafter be performed by the host server (block 522).

In summary, embodiments of the present invention provide a method of transferring data packets between a host and a client. This may involve receiving a data packet from a stack in the host and sending an acknowledgment packet to the stack. The data packet may be transmitted across an I/O bus. Accordingly, the acknowledgment packet may be sent to the stack without sending the acknowledgment packet across the I/O bus.

Any reference in this description to “one embodiment”, “an embodiment, example embodiment”, etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the knowledge of one skilled in the art to effect such feature, structure, or characteristic in connection with other ones of the embodiments. Furthermore, for ease of understanding, certain method procedures may have been delineated as separate procedures; however, these separately delineated procedures should not be construed as necessarily order dependent in their performance. That is, some procedures may be able to be performed in an alternative ordering, simultaneously, etc.

Further, embodiments of the present invention or portions of embodiments of the present invention may be practiced as a software invention, implemented in the form of a machine-readable medium having stored thereon at least one sequence of instructions that, when executed, causes a machine to effect the invention. With respect to the term “machine”, such term should be construed broadly as encompassing all types of machines, e.g., a non-exhaustive listing including: computing machines, non-computing machines, communication machines, etc. Similarly, which respect to the term “machine-readable medium”, such term should be construed as encompassing a broad spectrum of mediums, e.g., a non-exhaustive listing including: magnetic medium (floppy disks, hard disks, magnetic tape, etc.), optical medium (CD-ROMs, DVD-ROMs, etc), etc.

A machine-readable medium includes any mechanism that provides (i.e., stores and/or transmits) information in a form readable by a machine (e.g., a computer). For example, a machine-readable medium includes read only memory (ROM); random access memory (RAM); magnetic disk storage media; optical storage media; flash memory devices; electrical, optical, acoustical or other form of propagated signals (e.g., carrier waves, infrared signals, digital signals, etc.); etc.

Although the present invention has been described with reference to a number of illustrative embodiments thereof, it should be understood that numerous other modifications and embodiments can be devised by those skilled in the art that will fall within the spirit and scope of the principles of this invention. More particularly, reasonable variations and modifications are possible in the component parts and/or arrangements of the subject combination arrangement within the scope of the foregoing disclosure, the drawings and the appended claims without departing from the spirit of the invention. In addition to variations and modifications in the component parts and/or arrangements, alternative uses will also be apparent to those skilled in the art.

What is claimed is:

1. A method of transferring data packets between a server environment and a client, said method comprising:
receiving a data packet from a stack in said server environment;
sending an acknowledgment packet to said stack; and
transmitting said data packet across an I/O bus in said server environment, wherein said acknowledgment packet is sent to said stack without sending said acknowledgment packet across said I/O bus.

2. The method of claim 1, wherein said data packets comprise TCP/IP data packets.

3. The method of claim 1, further comprising storing information regarding said transmitted data packet in a network interface card.

4. The method of claim 3, further comprising transmitting said data packet across a network from said server environment to said client.

5. The method of claim 4, further comprising said network interface card monitoring acknowledgment packets regarding said data packet from said client.

6. The method of claim 5, further comprising recognizing an error condition if said acknowledgment packet regarding said transmitted data packet is not receiving from said client.

7. The method of claim 6, further comprising transmitting an indication of said error condition across said I/O bus.

8. A method of transferring data packets between a server and a client, said method comprising:
acknowledging a data packet based on a driver mechanism of said server receiving said data packet; and
transmitting said data packet across an I/O bus to a component of said server; and
storing information regarding said data packet at said component.

9. The method of claim 8, further comprising transmitting said data packet across a network from said server to said client.

10. The method of claim 8, further comprising said component monitoring an acknowledgment packet regarding said data packet from said client.

11. The method of claim 10, further comprising recognizing an error condition if said component does not receive said acknowledgment packet regarding said data packet from said client.

12. The method of claim 11, further comprising transmitting an indication of said error condition across said I/O bus.

13. The method of claim 8, wherein said data packet is acknowledged without sending an acknowledgment packet across said I/O bus.

14. The method of claim 8, wherein said data packet comprise a TCP/IP data packet.

15. A server environment comprising:
an operating system having a stack mechanism and a driver mechanism;
a network interface card; and
a I/O bus coupled between said operating system and said network interface card, wherein said driver mechanism to transmit a data packet across said I/O bus to said network interface card and said driver mechanism to send an acknowledgment packet regarding said data packet to said stack mechanism without transmitting said acknowledgment packet across said I/O bus.

16. The server environment of claim 15, wherein said data packet comprises a TCP/IP data packet.

17. The server environment of claim 15, wherein said network interface card to store information regarding said data packet transmitted across said I/O bus from said driver mechanism.

18. The server environment of claim 17, wherein said network interface card to transmit said data packet across a network to a client.

19. The server environment of claim 18, wherein said network interface card to monitor an acknowledgment packet regarding said data packet from said client.

20. The server environment of claim 19, wherein said network interface card to generate an error condition if said acknowledgment packet regarding said data packet is not received from said client.

21. The server environment of claim 20, wherein said network interface card to transmit said error condition across said I/O bus to said driver mechanism.

22. A network interface card comprising:
a mechanism to communicate across an I/O bus so as to receive data packets;
a memory device to store information regarding said received data packets; and
a mechanism to communicate across a network so as to transmit said received data packets to a remote system and to receive an acknowledgment packet from said remote system across said network.

23. The network interface card of claim 22, further comprising an error indicating mechanism to recognize an error condition if said acknowledgment packet regarding said data packet transmitted across said network is not received from said remote system.

24. The network interface card of claim 22, wherein said data packets comprise TCP/IP data packets.
